(19) United States
(12) Patent Application Publication
(10) Pub. No.: US 2012/0178837 A1
(43) Pub. Date: Jul. 12, 2012

(54) HIGH MELT STRENGTH POLYESTERS FOR FOAM APPLICATIONS

(76) Inventors: Sanjay Mehta, Spartanburg, SC (US); Rodolfo Agustin Flores, Shelby, SC (US)

(21) Appl. No.: 13/376,284

(22) PCT Filed: Jun. 3, 2010
(86) PCT No.: PCT/US10/37255

§ 371 Date: Apr. 2, 2012

Related U.S. Application Data
(60) Provisional application No. 61/184,429, filed on Jun. 5, 2009.

(51) Int. Cl. C08L 67/03; C08K 3/34; C08G 63/12; C08K 3/22

(52) U.S. Cl. 521/79; 525/418; 524/605; 524/430; 524/445; 528/272

(57) ABSTRACT

The present invention relates to a branched polyethylene terephthalate-co-isophthalate for use in the manufacture of foamed articles. The branched polyethylene terephthalate-co-isophthalate can be characterized by a composition comprising i) a polyethylene terephthalate-co-isophthalate comprising from about 5 to about 15 weight % of an isophthalic acid, and ii) a branching agent comonomer, wherein the branching agent comonomer is a polyhydric alcohol having functionality of 3 or more and the polyhydric alcohol is present in an amount of from 0.005 to about 0.01 equivalents per mole of total diacids. Other embodiments of the present invention include foamed articles produced from these compositions and processes to produce these compositions and the foamed articles.

### CROSS-REFERENCE TO RELATED APPLICATION

This application claims benefit of priority from U.S. Provisional Application No. 61/184,429 filed Jun. 5, 2009.

### FIELD OF THE INVENTION

The present invention relates to high melt strength polyester compositions, in particular for use in foamed articles. The polyester compositions relate to branched polyethylene terephthalate-co-isophthalate comprising multifunctional monomers.

### BACKGROUND OF THE INVENTION

Thermoplastic polyester resins such as polyethylene terephthalate (PET) have good mechanical characteristics, heat resistance, chemical resistance and dimensional stability. PET and copolyesters based on PET, are widely used in the fields of extrusion, injection molding and stretch blow molding to produce products such as fibres, containers and film.

Polyesters typically have low melt viscosity, low melt strength and low melt elasticity. Hence, molten PET tends to quickly collapse when foamed. Foamed PET also generally has poor mechanical properties, due to broad differences in cells sizes, cell wall thicknesses and the like.

Branched polyesters have been developed for foam applications to provide greater melt strength and elasticity. The use of various polyfunctional coupling agents such as pyromellitic dianhydride (PDMA) and polymeric epoxy compounds to introduce branching into polyesters in order to improve melt viscosity or melt strength is discussed in, for example, Ghana et al. U.S. Pat. No. 5,362,763 and Rotter et al. U.S. Pat. No. 5,288,764. Such reagents are generally added to the polyester as a masterbatch prior to melting in the extruder segment of the foaming process. This approach has the disadvantage that the degree of branching depends on the residence time and temperature that the composition is in the molten state. In addition unreacted coupling agents will remain in the foamed article.

Other conventional branching agents including diacids, dianhydrides, and polyhydroxy compounds blended with PET for extrusion into high melt strength PET for foaming applications (for example, Muschiatti U.S. Pat. No. 5,229,432).

In addition to the melt rheology limitations, linear polyesters also generally have poor melt stability, i.e. a loss of molecular weight during processing. The lack of melt stability of polyesters limits the ability to efficiently recycle polyester foam waste (regrind) back into the foaming process.

### SUMMARY OF THE INVENTION

A need exists for a high melt strength polyester composition that has good melt stability so that it can be blended with regrind for use in the preparation of foamed articles. In accordance with the present invention, a branched polyethylene terephthalate-co-isophthalate has been found which is a high melt strength polyester with good melt stability for use in the manufacture of foamed articles. An embodiment of the present invention is a composition comprising i) a polyethylene terephthalate-co-isophthalate comprising from about 5 to about 15 weight % of an isophthalic acid, and ii) a branching agent comonomer, wherein the branching agent comonomer is a polyhydric alcohol having functionality of 3 or more and the polyhydric alcohol is present in an amount of from about 0.005 to about 0.01 equivalents per mole of total diacids. The composition can have an intrinsic viscosity of about 0.85 to about 1.5 dl/g. The present invention also relates to methods to produce branched polyethylene terephthalate-co-isophthalate and foamed articles, and such foamed articles.

### DETAILED DESCRIPTION OF THE INVENTION

An embodiment of the present invention is a composition comprising i) a polyethylene terephthalate-co-isophthalate comprising from about 5 to about 15 weight % of an isophthalic acid, and ii) a branching agent comonomer, wherein the branching agent comonomer is a polyhydric alcohol having functionality of 3 or more and the polyhydric alcohol is present in an amount of from about 0.005 to about 0.01 equivalents per mole of total diacids.

The composition of the present invention is a high intrinsic viscosity, branched random copolyester of polyethylene terephthalate-co-isophthalate, and is manufactured by the incorporation of polyhydric alcohols in place of the ethylene glycol during polymerization.

The branched random copolyester of polyethylene terephthalate-co-isophthalate can be prepared from terephthalic and isophthalic acid (or their esters), a branching agent having a functionality greater than two, for example 3 or more or 4 or more, with ethylene glycol. A conventional melt polymerization process is used to obtain a polymer with an intrinsic viscosity of about 0.65 dl/g. Pellets of this precursor resin are then solid-state polymerized by standard methods to an IV of about 0.85 to about 1.5 dl/g, for example about 0.9 to about 1.2 dl/g.

The weight % of isophthalic acid (based on the copolyester) can be about 5 to about 15%, for example about 6 to about 10%. The inclusion of isophthalic acid reduces gel formation during solid state polymerization and lowers the melting point of the copolyester compared to the homopolymer. This lower melting point allows lower processing temperatures to be used in the extrusion foaming process, and reduces the IV loss during processing such that the waste foam can be ground and mixed with the virgin resin up to about 50%. Below about 5% of isophthalic acid, gels are formed at the range of branching agents contemplated for this inventive composition. At levels above about 15 weight % of isophthalate, the degree of crystallinity that can be formed in the foamed article, even with the use of nucleation agents, is insufficient to give the foamed article sufficient strength.

Polyhydric alcohols suitable for use as branching agents in the present invention have a functionality (f) of three or more and will be understood to have at least three hydroxy groups per molecule. For example, triethylol propane has a functionality of three and pentaerythritol has a functionality of four. Examples of suitable polyhydric alcohols and precursors thereto include glycerol, trimethylol propane, trimethylol ethane, pentaerythritol or ester thereof, dipentaerythritol, trip entaerythritol, etc. Particularly suitable polyhydric alcohols or derivatives thereof include pentaerythritol, trimethylol propane and ethoxylated trimethylol propane. Ethoxylated derivatives of the compounds can also be used. One or more polyhydric alcohols can be used in combination.

The equivalent molar mass of the polyhydric alcohol is its molar mass/f. The amount of the branching agent in the copolyester can be from about 0.005 equivalent to 0.01 equivalent per mole of total diacids, for example about 0.0075 to about 0.01 equivalent per mole of total diacids. For example, for pentaerythritol having a molar mass of 136 g/mole and f=4, the equivalent molar mass is 34 g/mole. The molar mass of terephthalic and isophthalic acid are both 166 g/mole. A composition containing 0.01 equivalent of pentaerythritol per mole of total diacids would have 0.34 g of pentaerythritol per 166 g of diacids corresponding to 1,000,000×0.34/166=2049 ppm of pentaerythritol, based on the weight of the diacids. Below about 0.005 equivalent per mole of total diacids of the branching, the high low shear viscosity required for stable and uniform cell formation during the extrusion foaming process is not reached, above about 0.01 equivalents per mole of total diacids, gelation starts to occur during polymerization.

The melt flow index (MFI) of the copolyesters is a measure of the zero shear viscosity of the composition, a high zero shear viscosity (low melt flow index) is required for uniform cells in the foamed article. The reduction of melt viscosity (or apparent viscosity as measured on a dynamic rheometer) with shear rate (shear thinning) is important in order to have a low viscosity resin during extrusion, prior to foaming, to minimize the temperature and pressure in the extrusion process which in turn minimizes the loss of the copolyester molecular weight during extrusion. Shear thinning, as expressed by the viscosity power factor, is typically less than about 0.6, and less than about 0.8 for the dynamic viscosity power factor. During the foaming process the melt undergoes high elongation deformations requiring high melt strength.

The dependence of the zero shear viscosity (η₀) on the weight average molecular weight (Mw) is well established for linear PET. Two regimes are separated by a critical molecular weight (Mc) below which ηₒ scales directly with Mw, and above which η₀ generally scales with Mw^{3.4}. Chains with molecular weights below Mc are too small to entangle, while the higher molecular weight chains are topologically constrained due to entanglement coupling. A value of Mc of about 55,000 g/mole is generally accepted for PET based on the lower η₀ of branched copolyesters compared to linear PET of the same Mw. For good foam density and stiffness the Mw is typically greater than this critical value of Mc, for example above 75,000 g/mole, for example above about 100,000 g/mole. As the level of branching increases, at a constant IV, the Mn decreases, the Mw remains about constant and the Mz increases, even though the melt flow index decreases.

The inventive composition can be defined in terms of its Mw and ratio of MFI to Mw. The Mw can be greater than about 75,000 g/mole, for example greater than 100,000 g/mole and the ratio of MFI, measured at 310° C. and a load of 2.06 kg, to Mw can be about 2×10⁻⁴ or less.

Properties of the polyester compositions of the present invention can also be modified by incorporation of various additives. These additives can be conventional organic fillers, such as carbon black, silica gel, alumina, clays and chopped fiber glass. An antioxidant can also be added to the composition to maintain good melt stability with the use of regrind during repeated processing. Other additives such as flame retardants, lubricants, tougheners, light stabilizers, plasticizers, pigments, barrier resins and the like can also be incorporated into the polyester composition of the present invention. Nucleating agents can also be added to the polymer composition to promote foaming and to control the degree of crystallinity in the foamed article. Suitably these nucleating agents are added to the inventive copolyester composition during the extrusion foaming process. Similarly, the other additives described above can be added at this stage of the process. To summarize, the additives can comprise at least one member selected from the group consisting of carbon black, silica gel, alumina, clays, chopped fiber glass, antioxidants, flame retardants, lubricants, tougheners, light stabilizers, plasticizers, pigments, barrier resins, nucleating agents and mixtures thereof.

Conventional extrusion techniques can be used to foam the polyester resins of the present invention, for example to densities less than 200 kg/m³. The polyester resin can be pre-blended or dry blended with all desired additives, prior to being fed into an extruder hopper, or all ingredients including the polyester resin can be added to the extruder hopper separately through the use of additive feeders. Selected components can be preblended physically or as melt blends prior to incorporation into the remainder of the components. The regrind material may be blended with the virgin polyester resin.

Another embodiment of the present invention is a method for producing a copolyester comprising: (a) melt polymerizing terephthalic and isophthalic acid, or their ester derivates, ethylene glycol, and a polyhydric alcohol to form a copolyester comprising about 5 to about 15 mole % isophthalic acid and about 0.005 to about 0.01 equivalents of polyhydric alcohol having an intrinsic viscosity of about 0.65 g/dl; (b) extruding the copolyester into a water bath, quenching and cutting the solid extrudate into pellets; and (c) crystallizing and solid state polymerizing pellets to an intrinsic viscosity of about 0.85 to about 1.5 dl/g.

Another embodiment of the present invention is a method for producing a foamed article comprising: (a) blending a branched polyethylene terephthalate-co-isophthalate copolyester having an isophthalic content of about 5 to about 15 mole % and a branching agent content from about 0.005 to about 0.01 equivalents/mole of total acids and an intrinsic viscosity of about 0.85 to about 1.5 dl/g with additives, wherein the branching agent is a polyhydric alcohol having a functionality of 3 or more; (b) melting the blend in an extruder; (c) adding a blowing agent to the molten mixture; and (d) extruding the resultant mixture to obtain a foamed article. Blowing agents can be low molecular weight hydrocarbons, such as isomers of butane and pentane, or carbon dioxide.

The additives can comprise at least one member selected from the group consisting of carbon black, silica gel, alumina, clays, chopped fiber glass, antioxidants, flame retardants, lubricants, tougheners, light stabilizers, plasticizers, pigments, barrier resins, nucleating agents and mixtures thereof.

Suitably the nucleating agents are added to the inventive copolyester composition during the extrusion foaming process. Similarly, the other additives can be added at this stage of the process.

Another embodiment is foamed articles which can be manufactured from the foams of the embodiments above include, for example, sheets for rigid foam insulation, sheets for thermoforming trays and other food packaging articles, other shapes for industrials end uses such as cores for composite articles.

### Experimental and Test Methods

The copolyesters are prepared by a conventional ester interchange reaction using dimethyl terephthalate and ethylene glycol catalyzed by manganese acetate. Once the monomer is formed, polyphosphoric acid is added to sequester the Mn catalyst, antimony trioxide added and the monomer polymerized under standard temperature (about 285 to about 290° C.) and vacuum conditions (less than 500 Pa) to form an amorphous resin having an IV of about 0.65 dl/g. The branching agent and isophthalic acid are added with the initial charge of DMT and ethylene glycol. The amorphous resin is crystallized and sold state polymerized in a vacuum rotating vessel at about 200° to about 215° C. until it reaches the required final IV.

The intrinsic viscosity of the copolyesters is calculated using the method of ASTM D 4603-96 using dichloroacetic acid (DCA) as the solvent at 25° C.

The melt index of the copolyesters is measured according to ASTM D 1238-04 using a weight of 2.06 kg. The melt viscosity of the copolyesters is measured according to ASTM 3835-02, and the dynamic viscosity according to ASTM D 440-07 using a Rheometrics parallel plate rheometer. The decrease in melt viscosity with shear rate (shear thinning) is characterized by the power factor, n, in the power law equation:

η=k·γⁿ

where is the melt viscosity and γ is the shear rate (s⁻¹). The viscosity power factor, n, is calculated from the ratio of melt viscosity at 50 and 1000 s⁻¹. A similar relationship can be used for the decrease in dynamic viscosity (η*) with angular shear frequency (ω, rads·s⁻¹):

η*=k′·ω^{n′}

The dynamic viscosity power factor, n′, is calculated from the ratio of dynamic viscosity between 1 and 100 rad·s⁻¹.

The melting point is measured according to ASTM D 3418-97.

The molecular weight distribution is measured by gel permeation chromatography (GPC) (Waters Corp.) calibrated with monodisperse polystyrene. 5 mg of the polymer is dissolved in 1.2 ml of 50/50 by volume hexafluoroisopropanol/chloroform and the solution diluted with 18.8 ml of chloroform.

The gel content is measured by dissolving 20 mg of the polymer in 6 ml of 50/50 by volume hexafluoroisopropanol/chloroform. The solution is diluted with 80 ml of chloroform and filtered through a 0.45 μm Teflon membrane. The difference in weight of the dry filter before and after filtration is expressed as a % of the original mass. In those samples in which gels are present, the GPC represents the molecular weight distribution of the soluble portion. The average molecular weights are based on the molecular weight distribution above 2000 daltons, to eliminate the influence of the small oligomers.

### EXAMPLES

### Example 1

A series of polyethylene terephthalate-co-isophthalate copolyesters were prepared using different amounts of isophthalic acid and pentaerythritol, polymerized to different final IV levels. The compositions and their melt characteristics were measured and set forth in Table 1. The comonomer amounts are expressed as weight % (or ppm) in the final copolyester, unless otherwise stated. The SSP times were in the range of 20 to 24 hours.

TABLE 1

| Run No. | 1 | 2 | 3 | 4 | 5 | 6 |
|---|---|---|---|---|---|---|
| IPA, wt. % | 2.6 | 6.5 | 2.6 | 6.5 | 6.5 | 6.5 |
| Pentaerythritol, ppm | 0 | 0 | 500 | 500 | 900 | 1500 |
| equiv./mole diacid | 0 | 0 | 0.002 | 0.002 | 0.004 | 0.007 |
| IV, dl/g | 0.84 | 1.06 | Gels | 1.06 | 1.17 | 1.17 |
| | | | formed | | | |
| Gel content, % | 0 | 0 | | 0 | <1 | <10 |
| Melt viscosity, Pa · s | | | | | | |
| 50 s⁻¹ | 775 | 1,400 | | 1,600 | 1,600 | 1,900 |
| 100 s⁻¹ | 700 | 1,100 | | 1,200 | 1,200 | 1,350 |
| 1000 s⁻¹ | 360 | 490 | | 450 | 435 | 470 |
| Viscosity power | 0.74 | 0.65 | | 0.58 | 0.56 | 0.53 |
| factor, n | | | | | | |
| MFI, 310° C., g/10 | 47 | | | 18 | 12 | 7 |
| min. | | | | | | |
| Melting Pt., ° C. | 248 | 236 | | 236 | 236 | 236 |
| Mn, g/mole | 26,170 | | | 49,295 | 31,024 | 24,755 |
| Mw, g/mole | 54,423 | | | 110,300 | 100,827 | 102,605 |
| Mz, g/mole | 79,680 | | | 221,503 | 254,350 | 302,255 |
| Mw/Mn | 2.08 | | | 2.24 | 3.25 | 4.15 |
| Mz/Mw | 1.46 | | | 2.01 | 2.52 | 2.95 |
| MFI/Mw, ×10⁴ | 8 | | | 1.6 | 1.2 | 0.7 |

### Example 2

A copolyester was prepared containing 6.5 wt. % IPA and 500 ppm (0.004 equiv./mole diacid) pentaerythritol having an IV of about 1.1 dl/g and a melting point of 234° C. This resin was extruded at 270° C. into a water bath and pelletized to give a resin with an IV of 0.88 IV. A 50/50 by weight, mixture of this extruded resin and virgin resin was blended and dried and extruded. This blend containing 50% “regrind” had an IV of 0.87 dl/g. The MWD and dynamic viscosity (η*) of the virgin resin, the extruded resin and the 50% regrind blend was measured at 280° C. and the results set forth in Table 2.

TABLE 2

| | Copolyester | Extruder copolyester | 50/50 blend |
|---|---|---|---|
| η*, Pa · s | | | |
| 1 rad · s−1 | 2,950 | 2,745 | 1,815 |
| 100 rad · s−1 | 880 | 710 | 605 |
| Dynamic viscosity | 0.74 | 0.71 | 0.76 |
| power factor, n′ | | | |
| Mn | 57,420 | 37,490 | 35,860 |
| Mw | 134,770 | 98,250 | 92,215 |
| Mz | 293,987 | 186,030 | 171,073 |
| Mw/Mn | 2.35 | 2.62 | 2.57 |
| Mz/Mw | 2.18 | 1.89 | 1.86 |

The small difference in Mw between the extruder copolyester and the Mw of the extruded composition of a blend of 50/50 virgin resin and extruded resin (regrind) is evidence that the use of multifunctional branching agent in a polyethylene terephthalate-co-isophthalate copolyester provides a composition suitable for extrusion foaming process that can recycle waste trimmings (regrind) up to a 50% level without a further reduction in molecular weight, while keeping the desired shear thinning (a viscosity power factor of about 0.8 or less).

While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

What is claimed is:

1. A composition comprising: i) a polyethylene terephthalate-co-isophthalate comprising from about 5 to about 15 weight % of an isophthalic acid, and ii) a branching agent comonomer, wherein said branching agent comonomer is a polyhydric alcohol having functionality of 3 or more and the polyhydric alcohol is present in an amount of from about 0.005 to about 0.01 equivalents per mole of total diacids.

2. The composition of claim 2 wherein said branching agent comonomer is a polyhydric alcohol having functionality of 4 or more.

3. The composition of claim 1 wherein said polyethylene terephthalate-co-isophthalate has an intrinsic viscosity in dichloroacetic acid at 25° C. of about 0.85 to about 1.5 dl/g.

4. The composition of claim 1 wherein the weight average molecular is about 75,000 g/mole or greater.

5. The composition of claim 1 wherein the ratio of the melt flow index at 310° C. with a load of 2.06 kg to the weight average molecular weight is about 2×10⁴ or less.

6. The composition of claim 1 wherein said polyhydric alcohol comprises at least one member selected from the group consisting of glycerol, trimethylol propane, trimethylol ethane, pentaerythritol or ester thereof, dipentaerythritol, tripentaerythritol, ethoxylated derivatives of this group, and mixtures thereof.

7. The composition of claim 1 further comprising an additive.

8. The composition of claim 7 wherein said additive comprises at least one member selected from the group consisting of carbon black, silica gel, alumina, clays, chopped fiber glass, antioxidants, flame retardants, lubricants, tougheners, light stabilizers, plasticizers, pigments, barrier resins, nucleating agents and mixtures thereof.

9. A method for producing a copolyester comprising:
a. melt polymerizing i) terephthalic and isophthalic acid, or their ester derivates, ii) ethylene glycol, and iii) a polyhydric alcohol to form a copolyester comprising about 5 to about 15 mole % isophthalic acid and about 0.005 to about 0.01 equivalents of polyhydric alcohol having an intrinsic viscosity of about 0.65 g/dl;
b. extruding said copolyester into a water bath, quenching and cutting the solid extrudate into pellets; and
c. crystallizing and solid state polymerizing pellets to an intrinsic viscosity of about 0.85 to about 1.5 dl/g.

10. A method for producing a foamed article comprising:
a. blending a branched polyethylene terephthalate-co-isophthalate copolyester having an isophthalic acid content of about 5 to about 15 mole % and a branching agent content from about 0.005 to about 0.01 equivalents/mole of total acids and an intrinsic viscosity of about 0.85 to about 1.5 dl/g with additives, wherein the branching agent is a polyhydric alcohol having a functionality of 3 or more;
b. melting the blend in an extruder;
c. adding a blowing agent to the molten mixture; and
d. extruding the resultant mixture to obtain a foamed article.

11. The composition of claim 10 wherein said additive comprises at least one member selected from the group consisting of carbon black, silica gel, alumina, clays, chopped fiber glass, antioxidants, flame retardants, lubricants, tougheners, light stabilizers, plasticizers, pigments, barrier resins, nucleating agents and mixtures thereof.

12. A foamed article comprising a branched polyethylene terephthalate-co-isophthalate copolyester having an isophthalic content of about 5 to about 15 mole % and a branching agent content from about 0.005 to about 0.01 equivalents/mole of total acids and an intrinsic viscosity of about 0.85 to about 1.5 dl/g and additives, wherein the branching agent is a polyhydric alcohol having a functionality of 3 or more.

13. The foamed article of claim 12 wherein the article is a selected from the group consisting of a sheet for insulation, thermoformed tray and other shapes for industrial end uses.
